(19) United States
(12) Patent Application Publication
(10) Pub. No.: US 2010/0007284 A1
(43) Pub. Date: Jan. 14, 2010

(54) DEVICE FOR DRIVING A GAS DISCHARGE LAMP

(75) Inventor: Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/445,466

(22) PCT Filed: Oct. 11, 2007
(86) PCT No.: PCT/IB07/54142

§ 371 Date: Apr. 14, 2009

(30) Foreign Application Priority Data
Oct. 17, 2006 (EP) 06122390.5

(51) Int. Cl. H05B 41/36

(52) U.S. Cl. 315/209 R

(57) ABSTRACT

A driver (10) for driving a gas discharge lamp (11), preferably implemented as half-bridge converter, has two states, corresponding to rising lamp current (dI/dt>0) and falling lamp current (dI/dt<0), respectively. A controller (12) always changes state (SS1→SS2; SS2→SS1) at predetermined phases (φs=2/8; φs=6/8) of the lamp current. At other predetermined phases (φs=1/8; φs=3/8; φₛ=5/8; φₛ=7/8), the controller randomly decides whether or not to change state (SS1→SS2; SS2→SS1), wherein the probability (p) for changing is larger than 0 and lower than 1. As a result, the frequency spectrum of the lamp power is smoothened, the power at individual frequencies being reduced, so that the probability of stimulating acoustic resonances in the lamp are reduced.

### FIELD OF THE INVENTION

The present invention relates in general to a method and device for driving a gas discharge lamp, using an alternating lamp current. The present invention relates specifically to the driving of a High Intensity Discharge lamp (HID), i.e. a high-pressure lamp, such as for instance a high-pressure sodium lamp, a high-pressure mercury lamp, a metal-halide lamp. In the following, the invention will be specifically explained for a HID lamp, but application of the invention is not restricted to a HID lamp, as the invention can be more generally applied to other types of gas discharge lamps.

### BACKGROUND OF THE INVENTION

Gas discharge lamps are known in the art, so an elaborate explanation of gas discharge lamps is not needed here. Suffice it to say that a gas discharge lamp comprises two electrodes located in a closed vessel filled with an ionizable gas or vapor. The vessel is typically quartz or a ceramic, specifically polychrystalline alumina (PCA). The electrodes are arranged at a certain distance from each other, and during operation an electric arc is maintained between those electrodes.

Specific types of gas discharge lamps have been developed for specific use in different applications, such as a projection system, an illumination system.

An important problem of gas discharge lamps is the possibility of acoustic resonances, i.e. pressure resonances, occurring generally in the range from 9 kHz to 1 MHz, and this problem is particularly serious in the case of HID lamps. As a result of acoustic resonances, the behavior of the arc becomes unpredictable, and possibly unstable; the arc can touch the vessel, damaging the vessel, and the arc can extinguish. Also, acoustic resonances in the audible frequency range may lead to audible noise, which is annoying.

Acoustic resonances involve resonant pressure variations, and an important source of pressure variations are power variations: if the lamp power varies, power dissipation in the arc varies, causing variation in the generated heat and hence in the pressure. Thus, it is desirable to operate the lamp with constant power.

One obvious way of operating a discharge lamp with constant power is DC operation. However, DC operation also involves some disadvantages, including asymmetric erosion of the electrodes. In order to avoid these disadvantages, it is known to operate a discharge lamp with commutating DC current, i.e. a lamp current which has constant magnitude but alternating direction.

Currently, the standard driver for a HID lamp has a design comprising a down-converter followed by a full bridge commutation circuit and a resonant ignition circuit. This design operates satisfactorily. However, there is a desire to reduce the costs of the lamp driver.

A driver design that has lower cost than the above-mentioned standard driver is a half-bridge circuit. Such design is generally illustrated in FIG. 1, which is a block diagram of an exemplary lamp driver 10 for driving a gas discharge lamp 11 in accordance with prior art. Since such half-bridge circuit topology should be known to persons skilled in the art, the design and functioning will be described only briefly. Two switches M1 and M2 are arranged in series, with corresponding diodes D1, D2, between two voltage rails coupled to a source of substantially constant voltage V. The design of this voltage source is not relevant for the present invention. Two capacitors C1 and C2 are also arranged in series between the two voltage rails. The lamp 11 is coupled between on the one hand the junction between the two switches M1 and M2 and on the other hand the junction between the two capacitors C1 and C2, with an inductor L arranged in series with the lamp 11 and a capacitor C arranged in parallel with the lamp 11. The two switches M1 and M2 are controlled alternately by a controller 12, such that they are never closed (i.e. conductive) at the same time. The two capacitors C1 and C2 have relatively high capacitive values, and the switching frequency of the two switches M1 and M2 is relatively high, so that the voltage at the junction between the two capacitors C1 and C2 is virtually constant.

The operation is as follows. In a first switching state SS1, the upper switch M1 is closed, the lower switch M2 is open (i.e. non-conductive), and the lamp current I (equal to the current through the inductor) is rising. In a second switching state SS2, the lower switch M2 is closed, the upper switch M1 is open, and the lamp current is decreasing. The circuit is successively in its first and second switching state. The current reaches a maximum value at the transition from the first to the second switching state. The current reaches a minimum value at the transition from the second to the first switching state. Control is such that the current wave form is symmetrical with respect to zero, i.e. the said minimum current value has the same magnitude as the said maximum value but opposite direction. A full current cycle contains the combination of one first switching state and one second switching state.

The lamp may be assumed to behave like a voltage source, i.e. the voltage over the lamp is constant during each switching state. Consequently, the voltage over the inductor L is constant during each switching state, so that the current increase during the first switching state SS1 and the current decrease during the second switching state SS2 are linear with time: the time-derivative dI/dt=constant. This implies that the current waveform is triangular, as illustrated in FIG. 2, which schematically shows lamp current I (upper graph) and corresponding lamp power P (lower graph) as a function of time. The lamp power P also has a triangular waveform, but the frequency is twice the frequency of the current. The current period is indicated as T, which is twice the period of the power.

It is noted that the above description, and the corresponding illustration in FIG. 2, models the current behavior in a somewhat idealistic manner. In reality, the lamp behaves more resistive in the kHz range, but the lamp current I fluctuates nevertheless at a constant period T, and so does the lamp power at a constant period T/2; therefore, for illustrative purposes, the triangular waveform will be continued for use in explaining the present invention.

The use of half-bridge circuits is attractive because such circuit is the standard driver topology for fluorescent lamps, implying that these circuits are well available and have relatively low cost. However, the periodically fluctuating current magnitude and correspondingly fluctuating lamp power pose a problem in HID lamps, because such power variations, as explained above, may lead to resonances.

### SUMMARY OF THE INVENTION

An object of the present invention is to eliminate or at least reduce the above-mentioned problems.

Specifically, an object of the present invention is to provide a method for driving gas discharge lamps with high-frequency alternating lamp current, and a lamp driver for performing the method, such that the probability of acoustic resonances being induced by power variations is reduced.

Also, it is a specific objective of the present invention to modify a standard half-bridge circuit for implementing the method. More specifically, the present invention aims at providing a solution that can be implemented by modifying the software of the controller of such standard half-bridge circuit without the necessity of modifying its hardware.

According to an important aspect of the present invention, the switching moments of the driver are randomized. As a result, the phase of the current is caused to make random jumps, and consequently, the pressure variations induced by current variations are no longer periodic with one specific frequency but they are spread out in a frequency range, while the power contribution at single frequencies is substantially reduced.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating a lamp driver with half-bridge topology;

FIG. 2 is a time diagram schematically showing the lamp current and lamp power as a function of time;

FIG. 3 is a time diagram comparable to FIG. 2, illustrating different phases of the current cycle;

FIG. 4 is a diagram illustrating the decision-processes at several moments of the current cycle;

FIG. 5 is a time diagram comparable to FIG. 3, showing different phase-shifted waveforms;

FIGS. 6-7 are graphs illustrating the frequency spectra of lamp current and lamp power in some exemplary simulations;

FIGS. 8-9 are graphs illustrating the frequency spectra of lamp current and lamp power in another example;

FIG. 10 is a flow diagram illustrating the operation of the lamp driver.

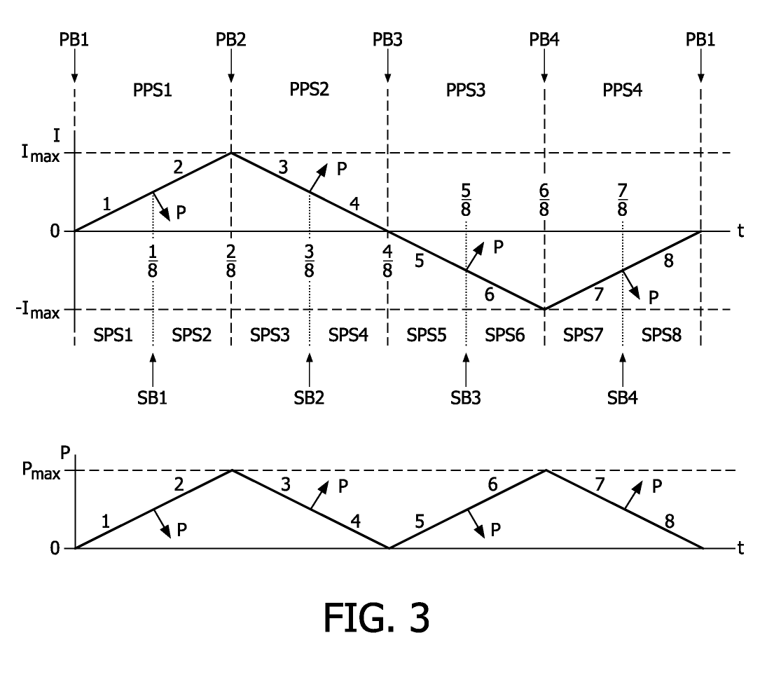

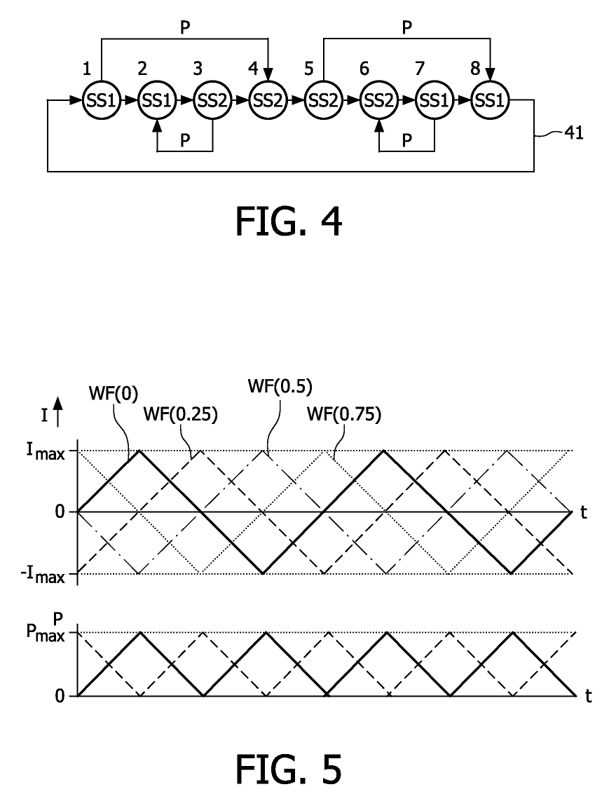

FIG. 3 is a time diagram, comparable to FIG. 2, illustrating one complete current cycle or current period. The horizontal axis represents time, which is taken to be zero when the current crosses zero in an arbitrary direction, which is taken to be the rising direction. In the following, a phase φ will be defined as φ=t/T, so that the phase φ ranges from 0 to 1 for a complete current period. The numbers along the horizontal axis in FIG. 3 represent phase.

For describing the behavior of the controller 12, the phase domain is divided into phase segments, which are traveled sequentially by the controller 12; a situation corresponding to a certain phase segment will be indicated by the phrase “state”. Phase segments are bordered by phase borders, which indicate for the controller 12 a state transition from one state to another state.

In prior art, phase borders are located at phases 0, 1/4, 2/4, 3/4 (and 1, which is equivalent to 0).
φ=1/4 corresponds to maximum positive current magnitude I_{MAX};
φ=3/4 corresponds to maximum negative current magnitude I_{MAX};
φ=0 corresponds to current is zero and increasing;
φ=1/2 corresponds to current is zero and decreasing.

These borders will be indicated as “primary phase borders” PB1, PB2, PB3, PB4, and the phase segments defined in this way will be indicated as “primary phase segments” PPS1, PPS2, PPS3, PPS4. These primary phase segments will further be characterized by the phrases “positive” or “negative”, depending on the sign of the current, and by the phrases “rising” or “falling”, depending on the sign of the time-derivative of the current.

According to the invention, at least one further phase border is added. Such added phase border will be indicated as “secondary phase border” SB1, SB2, SB3, SB4. A secondary phase border will always be located between a pair of two consecutive primary phase borders, i.e. be located within a primary phase segment. In the preferred embodiment discussed below, always exactly one secondary phase border is located between each pair of two consecutive primary phase borders, i.e. each primary phase segment contains precisely one secondary phase border. It is noted, however, that this is not essential: it is possible that there are primary phase segments containing no secondary phase border, but it is also possible that there are primary phase segments containing two or even more secondary phase borders. In such cases, however, with a view to symmetry, it is preferred that the number of secondary phase borders in the rising positive primary phase segment PPS1 is equal to the number of secondary phase borders in the falling negative primary phase segment PPS3, and that the number of secondary phase borders in the falling positive primary phase segment PPS2 is equal to the number of secondary phase borders in the rising negative primary phase segment PPS4.

The phase segments defined between neighboring phase borders, secondary and/or primary, will be indicated as “secondary phase segments” SPS1, SPS2, SPS3, SPS4, SPS5, SPS6, SPS7, SPS8. In the following, the phrase “controller state” will be used to indicate in which state the controller momentarily operates, while a specific controller state always corresponds to a specific secondary phase segment. Thus, in the preferred embodiment, there are eight controller states, corresponding to the eight secondary phase segments.

In the embodiment illustrated, the secondary phase borders SB1, SB2, SB3, SB4 are located at φ=1/8, 3/8, 5/8, 7/8, so that the eight secondary phase segments SPS1, SPS2, SPS3, SPS4, SPS5, SPS6, SPS7, SPS8 have mutually equal duration. However, this also is not essential. More generally, in each primary phase segment, the location φ_{S} of a secondary phase border (if any) can be expressed as φ_{S}=φ_{P}Δφ, wherein φ_{P} indicates the phase of the primary phase border at the start of this primary phase segment, and wherein Δφ is a constant value that is equal for all primary phase segments. Thus, in the embodiment illustrated, this constant value Δφ, which will be indicated by the phrase “phase offset”, is equal to 1/8.

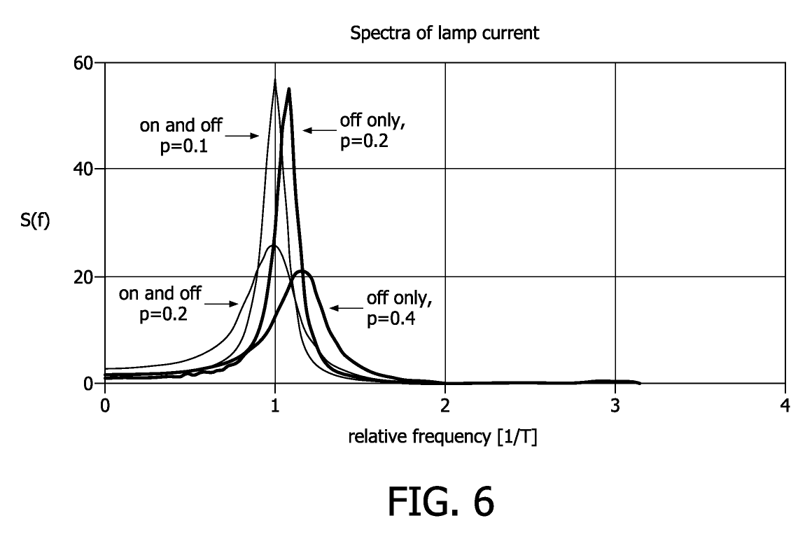

FIG. 4 is a diagram, schematically showing the eight controller states as circles numbered 1-8. Operation in accordance with prior art means that the controller 12 travels these eight controller states 1-8 successively, and then returns to the first controller state 1, as indicated by loop 41. The switching states SS1 or SS2 are indicated in said circles. Such prior art operation means that, at all times when approaching a phase border, the controller makes a transition to the state corresponding to the immediately following phase segment.

A controller 12 which is programmed in accordance with the present invention operates differently. At the primary phase borders PB1, PB2, PB3, PB4, the controller 12 makes a transition to the state corresponding to the immediately following phase segment, as before: this corresponds to the transitions 23, 45, 67 and 81 in FIG. 4. However, at the secondary phase borders SB1, SB2, SB3, SB4, the controller 12 has a choice from two options: the first option is to maintain the switching state of the switches M1 and M2, the other option is to change the switching state of the switches M1 and M2. The first option corresponds to continuation of the increase or decrease, respectively, of the current, whereas the second option corresponds to reversing the sign of the time-derivative of the current, i.e. a transition from increase to decrease or from decrease to increase, respectively. Thus, the first option corresponds to the transitions 12, 34, 56, 78 in FIG. 4, while the second option corresponds to the transitions 14, 32, 58, 76 in FIG. 4.

The controller 12 makes its decision which option to choose at random, with the proviso that the probability p of choosing the second option has a predetermined fixed value higher than 0 and lower than 1 (the same applies of course to the probability 1−p of choosing the first option). In the preferred embodiment, this probability p has the same value at all secondary phase borders, but this is not essential: at individual secondary phase borders with corresponding phase φ_{S}, the probability p may have different values p(φ_{S}), which probabilities are constant in time. However, with a view to symmetry, p(φ_{S})=p(φ_{S}+0.5) should apply. Further, in the preferred embodiment, this probability p is equal to 0.5.

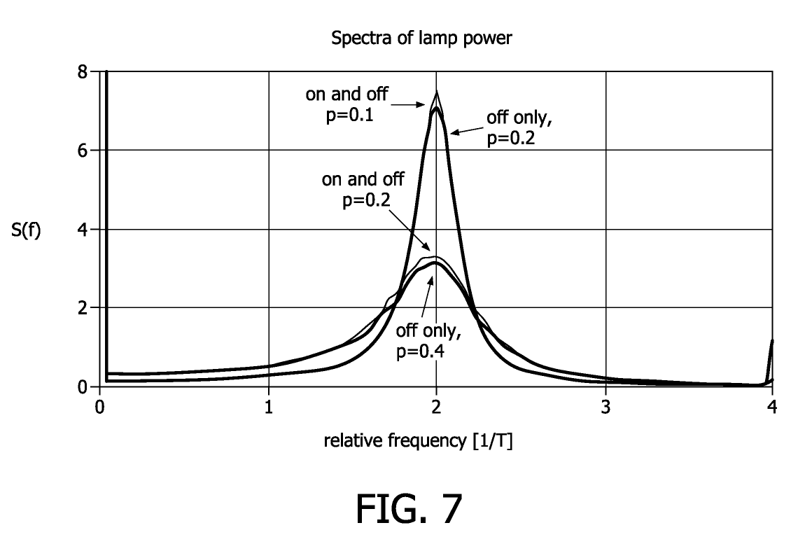

FIG. 5 is a diagram comparable to FIG. 3, illustrating the waveforms of current and power in a case where the controller 12 makes the following state journey: 1→4→5→6→7→6→7→8→1→2→3→2→3→4

It is noted that when the controller 12 chooses the second option of changing the switching states of the switches M1 and M2, this involves a shift of the phase of the current waveform, either increasing or decreasing the time-interval between successive zero-crossings. In the embodiment discussed, these phase shifts have value +0.25 or −0.25. Based on an absolute time base, this means that the current can follow any of the waveforms WF(0), WF(0.25), WF(0.5), WF(0.75), wherein WF(0) indicates the original waveform of the current (see FIG. 2), and wherein the value between brackets indicates a phase shift of that waveform with respect to the original waveform. At any arbitrary moment in time, all of these waveforms have the same probability (i.e. 0.25). Thus, the expectation value of the average current is zero at all times. Likewise, the expectation value of the average power is P_{MAX}/2 at all times. This makes the embodiment of Δφ=1/8, especially in combination with p=0.5, to be the preferred embodiment.

It is noted that the transitions 1→4 and 5→8 involve switching the transistors M1, M2 during increasing current magnitude, i.e. the conductive transistor is switched OFF before the maximum current value is reached; this will be indicated as “ON→OFF switching”, and is comparable to the switching at the transitions 2→3 and 6→7 yet at different current levels. On the other hand, the transitions 3→2 and 7→6 involve switching the transistors M1, M2 during decreasing current magnitude, i.e. the non-conductive transistor is switched ON while the current is being conducted by the other transistor; this will be indicated as “OFF→ON switching”, and is comparable to continuous mode switching. Using both modes of switching has the advantage that average current, average power and average frequency are maintained unaffected. However, the continuous mode switching may lead to additional losses due to the necessary charge removal from the conducting body diode in the case of MOS transistors. If it is desired that this is avoided, it is possible to apply ON→OFF switching only, but then the average current magnitude and average power are reduced somewhat, depending on the value of p.

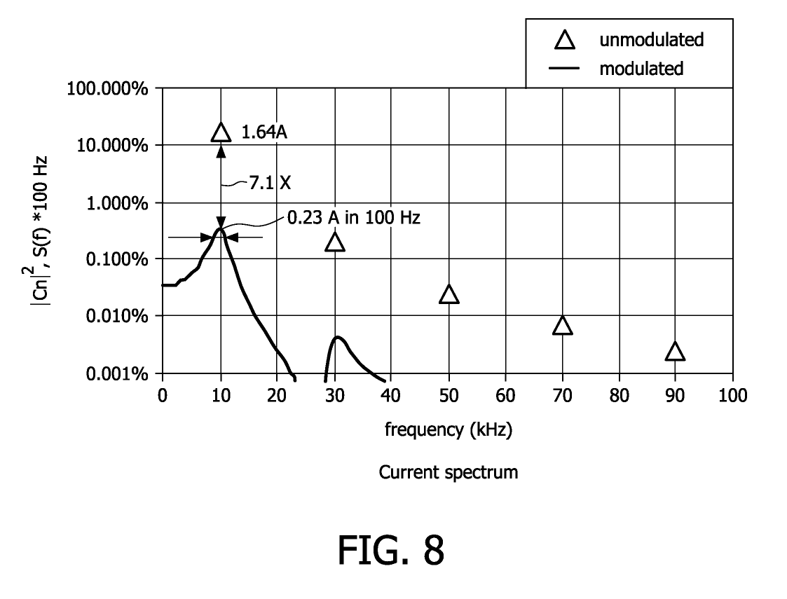

The effect of the invention is illustrated by simulation, using the embodiment described above, i.e. φ_{S}=0.25, both for the case of ON→OFF switching only and the case of ON→OFF switching as well as OFF→ON switching, and for two different values of p. The resulting frequency spectra of current and power are shown in FIGS. 6-7. Referring to the power spectrum of FIG. 7, it can be seen that the spectrum has widened around the basic frequency 2/T, wherein the amount of widening and associated reduction of spectral magnitude at the basic frequency 2/T depend on the value of p. This results in reduced excitation of lamp resonances.

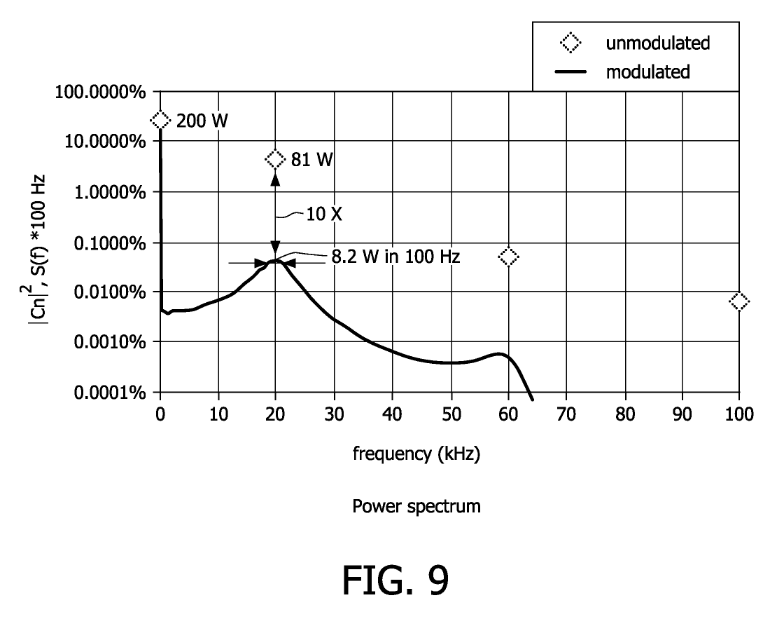

Another example is illustrated in FIGS. 8-9. This example is based on a 200 W HID lamp operated at a current frequency of 10 kHz. Both ON→OFF switching as well as OFF→ON switching are applied, φ_{S}=0.25, p=0.5, so that the resulting (idealized) waveforms can be seen in FIG. 5. Frequency spectra of current and power were calculated by simulation. Long random sequences of states were generated, followed by calculation of autocorrelation functions of current and power. The spectra were obtained by Fourier transforming (Wiener Khintchine theorem). For comparison, the Fourier coefficients of the unmodulated case (corresponding to p=0) were calculated and included in the graphs: these discrete coefficients are shown as open triangles in FIG. 8 and open squares in FIG. 9. FIGS. 8-9 show that in the case of operation in accordance with the present invention, there are no distinct spectral peaks any more, and that the sensitivity for resonances has been reduced. At the basic frequency of 20 kHz, the unmodulated case has a power contribution of 81 W. In the case of the random modulation of the switching moments in accordance with the invention, and assuming a resonance bandwidth of 100 Hz, the power frequency spectrum has a power content of 8.2 W at 20 kHz, hence a power improvement of factor 10. The current frequency spectrum does not show any discrete components either, and the variations in the instantaneous current are well below the unmodulated case.

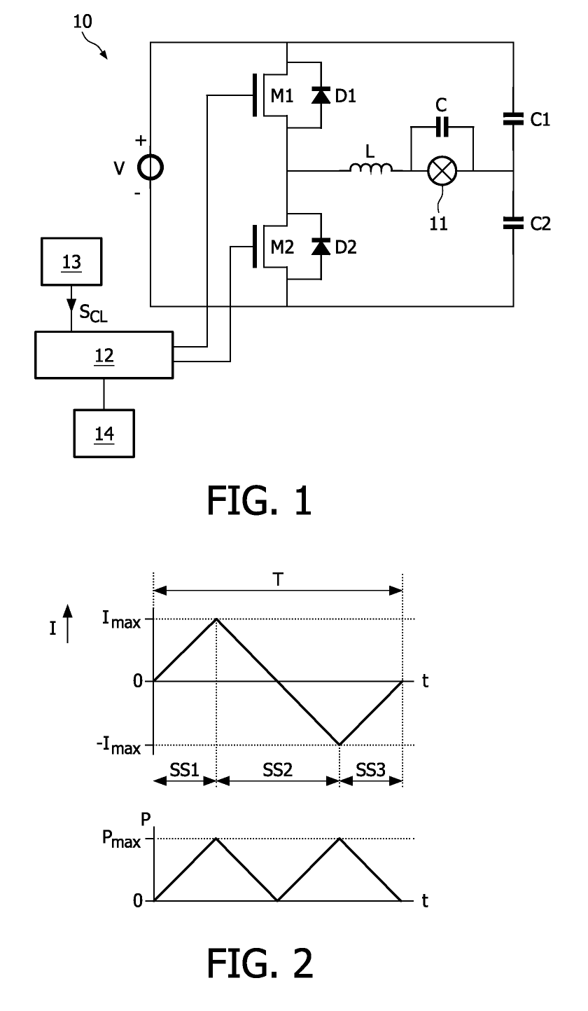

It is noted that the phase borders may be defined in terms of current magnitude. For instance, it is possible to predefine a maximum current level I_{MAX} and to define a second current level I2=I_{MAX}/2, and it is possible for the controller 12 to constantly monitor the instantaneous current magnitude and compare this with the second current level I2, and to randomly decide whether or not to change the switching state of the switches M1, M2 when the instantaneous current magnitude crosses the second current level I2. However, the present invention is more conveniently implemented by time-control. The controller 12 is provided with a clock signal generator 13, generating a clock signal SCL, and a counter 14. The clock signal generator 13 may be an integral part of the controller 12, but is shown as an external device in FIG. 1. The same applies to the counter 14. The clock signal has a fixed frequency f_{CL} and a corresponding clock period t_{CL}=1/f_{CL}. The current period T is defined as a predetermined number N_{T} of clock cycles. The duration N_{SBS} of the eight secondary phase segments SPS1, SPS2, SPS3, SPS4, SPS5, SPS6, SPS7, SPS8 is defined as a predetermined number N_{SBS} of clock cycles as well, with N_{SBS}=N_{T}/8, which should at least be equal to 1 but which preferably is in the order of at least 10.

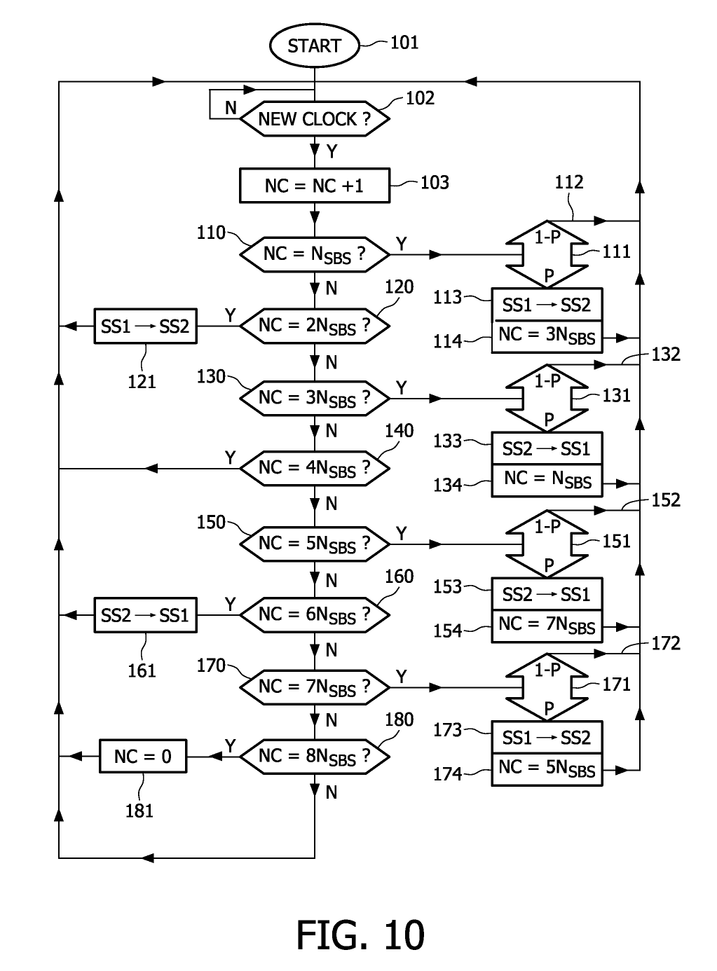

The operation of the controller 12 is illustrated in the flow diagram of FIG. 10. The explanation starts [step 101] at time t=0: the value NC of the counter is zero, the instantaneous current I(t) is zero, and the driver 10 is in its first switching state SS1. The current is increasing.

In step 102, the controller 12 detects the arrival of a new clock event (which may be a clock pulse, or a triggering edge, etc). On the detection of a new clock event, the controller 12 increases the counter value NC of the counter 14 by 1 (step 103), and checks the new value NC.

In step 110, the controller 12 checks whether counter value NC is equal to N_{SBS}, which would mean that the first secondary phase border SB1 is reached (i.e. (φ=1/8).

If not, the controller 12 checks in step 120 whether counter value NC is equal to 2N_{SBS}, which would mean that the second primary phase border PB2 is reached (i.e. (φ=2/8).

If not, the controller 12 checks in step 130 whether counter value NC is equal to 3N_{SBS}, which would mean that the second secondary phase border SB2 is reached (i.e. φ=3/8).

If not, the controller 12 checks in step 140 whether counter value NC is equal to 4N_{SBS}, which would mean that the third primary phase border PB3 is reached (i.e. (φ=4/8).

If not, the controller 12 checks in step 150 whether counter value NC is equal to 5N_{SBS}, which would mean that the third secondary phase border SB3 is reached (i.e. (φ=5/8).

If not, the controller 12 checks in step 160 whether counter value NC is equal to 6N_{SBS}, which would mean that the fourth primary phase border PB4 is reached (i.e. (φ=6/8).

If not, the controller 12 checks in step 170 whether counter value NC is equal to 7N_{SBS}, which would mean that the fourth secondary phase border SB4 is reached (i.e. (φ=7/8).

If not, the controller 12 checks in step 180 whether counter value NC is equal to 8N_{SBS}, which would mean that the first primary phase border PB1 (of the next current cycle) is reached (i.e. φ=8/8). If this is the case, the counter 14 is reset (step 181) and the controller returns to step 102.

If none of the above-mentioned phase borders are reached, the controller simply returns to step 102.

If in step 120 it appears that the counter value NC is equal to 2N_{SBS}, the controller changes the switch state from the first state SS1 to the second state SS2 (step 121) and returns to step 102.

If in step 140 it appears that the counter value NC is equal to 4N_{SBS}, the controller simply returns to step 102. It is noted that this step 140 may also be skipped. If in step 160 it appears that the counter value NC is equal to 6N_{SBS}, the controller changes the switch state from the second state SS2 to the first state SS1 (step 161) and returns to step 102.

If in step 110 it appears that the counter value NC is equal to N_{SBS}, the controller 12 enters a selection step 111, where the controller randomly makes a selection from two options. In the first option 112, which has a probability 1−p, the controller simply returns to step 102. In the second option, which has a probability p, the controller changes the switch state from the first state SS1 to the second state SS2 (step 113), changes the counter value to 3N_{SBS} (reflecting the phase jump; step 114), and returns to step 102.

If in step 130 it appears that the counter value NC is equal to 3N_{SBS}, the controller 12 enters a selection step 131, where the controller randomly makes a selection from two options. In the first option 132, which has a probability 1−p, the controller simply returns to step 102. In the second option, which has a probability p, the controller changes the switch state from the second state SS2 to the first state SS1 (step 133), changes the counter value to N_{SBS} (reflecting the phase jump; step 134), and returns to step 102.

If in step 150 it appears that the counter value NC is equal to 5N_{SBS}, the controller 12 enters a selection step 151, where the controller randomly makes a selection from two options. In the first option 152, which has a probability 1−p, the controller simply returns to step 102. In the second option, which has a probability p, the controller changes the switch state from the second state SS2 to the first state SS1 (step 153), changes the counter value to 7N_{SBS} (reflecting the phase jump; step 154), and returns to step 102.

If in step 170 it appears that the counter value NC is equal to 7N_{SBS}, the controller 12 enters a selection step 171, where the controller randomly makes a selection from two options. In the first option 172, which has a probability 1−p, the controller simply returns to step 102. In the second option, which has a probability p, the controller changes the switch state from the first state SS1 to the second state SS2 (step 113), changes the counter value to 5N_{SBS} (reflecting the phase jump; step 174), and returns to step 102.

Summarizing, the present invention provides a driver 10 for driving a gas discharge lamp 11, preferably implemented as half-bridge converter, having two switch states, corresponding to rising lamp current (dI/dt>0) and falling lamp current (dI/dt<0), respectively. A controller 12 always changes switch state (SS1→SS2; SS2→SS1) at predetermined phases (φ_{S}=2/8; φ_{S}=6/8) of the lamp current.

At other predetermined phases (φ_{S}=1/8; φ_{S}=3/8; φ_{S}=5/8; φ_{S}=7/8), the controller randomly decides whether or not to change switch state (SS1→SS2; SS2→SS1), wherein the probability p for changing is larger than 0 and lower than 1.

As a result, the frequency spectrum of the lamp power is smoothened, the power at individual frequencies being reduced, so that the probability of stimulating acoustic resonances in the lamp are reduced.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, although it is desirable to use a half-bridge configuration, the advantages described above are also obtained when a full-bridge configuration is used.

Further, it is not essential that |dI/dt| during the first switch state SS1 is equal to |dI/dt| during the second switch state SS2.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Driver (10) for driving a gas discharge lamp (11), the driver comprising controllable switches (M1, M2) and a controller (12) for controlling the switches, the controller having a first switch state (SS1) in which the controlled condition of the switches is such that the time-derivative (dI/dt) of the lamp current (I) is positive, and having a second switch state (SS2) in which the controlled condition of the switches is such that the time-derivative (dI/dt) of the lamp current (I) is negative;
the controller being designed for always changing from the first switch state (SS1) to the second switch state (SS2) at a first predetermined phase (φ_{S}=2/8) of the lamp current and for always changing from the second switch state (SS2) to the first switch state (SS1) at a second predetermined phase (φ_{S}=6/8) of the lamp current;
the controller being designed for randomly deciding whether or not to change from the first switch state (SS1) to the second switch state (SS2) at at least one third predetermined phase (φ_{S}=1/8; φ_{S}=7/8) between the second predetermined phase (φ_{S}=6/8) and the first predetermined phase (φ_{S}=2/8), wherein the probability (p) for changing is larger than 0 and lower than 1;
and the controller being designed for randomly deciding whether or not to change from the second switch state (SS2) to the first switch state (SS1) at at least one fourth predetermined phase (φ_{S}=3/8; φ_{S}=5/8) between the first predetermined phase (φ_{S}=2/8) and the second predetermined phase (φ_{S}=6/8), wherein the probability (p) for changing is larger than 0 and lower than 1.

2. Driver according to claim 1, wherein the probability for said random change from the second switch state (SS2) to the first switch state (SS1) is equal to the probability for said random change from the first switch state (SS1) to the second switch state (SS2).

3. Driver according to claim 1, wherein said third predetermined phase (φ_{S}=1/8) and said fourth predetermined phase (φ_{S}=5/8) coincide with increasing current magnitude, and wherein the switch state is always maintained when the absolute value of the current magnitude is decreasing.

4. Driver according to claim 3, wherein the phase difference between said third predetermined phase (φ_{S}=1/8) and said second predetermined phase (φ_{S}=6/8) is equal to the phase difference between said fourth predetermined phase (φ_{S}=5/8) and said first predetermined phase (φ_{S}=2/8).

5. Driver according to claim 1, wherein said controller is designed for randomly deciding whether or not to change from the first switch state (SS1) to the second switch state (SS2) at two predetermined phases (φ_{S}=7/8, φ_{S}=1/8) between the second predetermined phase (φ_{S}=6/8) and the first predetermined phase (φ_{S}=2/8);
and wherein said controller is designed for randomly deciding whether or not to change from the second switch state (SS2) to the first switch state (SS1) at two predetermined phases (φ_{S}=3/8, φ_{S}=5/8) between the first predetermined phase (φ_{S}=2/8) and the second predetermined phase (φ_{S}=6/8).

6. Driver according to claim 5, wherein said controller is designed for randomly deciding whether or not to change switch states at phases Δφ, 1/4+Δφ, 1/2+Δφ, 3/4+Δφ.

7. Driver according to claim 6, wherein Δφ=1/8.

8. Driver according to claim 1, implemented as a half-bridge converter.

9. Driver according to claim 1, implemented as a full-bridge converter.

10. Driver according to claim 1, wherein the lamp is a high-pressure gas discharge lamp.

11. Driver according to claim 1, wherein the lamp is used in a projection system.

12. Driver according to claim 1, wherein the lamp is used in an illumination system.
